(19) United States
(12) Patent Application Publication
(10) Pub. No.: US 2003/0003290 A1
(43) Pub. Date: Jan. 2, 2003

(54) Sealing material in the form of tape, and production thereof

(76) Inventors: Hirokazu Hisano, Ako-shi (JP); Masayuki Aso, Yokohama-shi (JP)

Correspondence Address: W. L. Gore & Associates, Inc., 551 Paper Mill Road, P.O. Box 9206, Newark, DE, 19714-9206, US

(21) Appl. No.: 10/077,599

(22) Filed: Feb. 15, 2002

(30) Foreign Application Priority Data
Feb. 19, 2001 (JP) 01-42515

(51) Int. Cl. B32B 3/26; B32B 3/06; B32B 5/14; B32B 7/12; B32B 9/00; B32B 27/00; B32B 15/04

(52) U.S. Cl. 428/308.4; 428/304.4; 428/317.1; 428/318.4; 428/319.3; 428/319.7; 428/352; 428/306.6

(57) ABSTRACT

Expanded porous polytetrafluoroethylene film laminated into a laminate in the form of a strip, wherein the laminated height of the laminated strip is greater than the width, preferably with a layer for preventing fluid penetration interposed between the layers of the laminate. The sealing material in the form of tape is used in the form of a closed ring, the longitudinal beginning and end being joined, and the laminated end faces on the long side are in contact with the tightened surfaces, in such a way that the direction in which the laminated strip has been laminated is the radial direction.

### FIELD OF THE INVENTION

The present invention relates to a sealing material in the form of tape which is used to seal pipe flanges, tank manhole lids, and other industrial machines and the like, as well as to its use in producing a sealing material in the form of a closed ring, and its method of production, and in particular relates to a seal for use in areas characterized by considerable strain at the tightening surface in contact with the sealing material, such as glass-lined containers, resin-lined pipes or containers, and aluminum containers, or where the device itself will break or deform when excessive load is exerted on the seal, as well as to a sealing material in the form of a closed ring which is suitable for applications requiring high sealing performance at low tightening pressure, such as electrolytic tanks or semiconductor devices, and to sealing materials in the form of tape which can be used to economically produce such seals in the form of closed rings, and methods for their production.

### BACKGROUND OF THE INVENTION

Sealing materials made of polytetrafluoroethylene (PTFE), which is characterized by exceptional corrosion resistance, have been widely used in the joints of pipes through which corrosive fluids flow in the fields of pharmaceuticals, food products, chemistry, and the like.

The sealing material in the form of a ring disclosed in Japanese Examined Patent Application (Kokoku) 57-58450, for example, is obtained by joining a ring-shaped layer comprising sintered unexpanded polytetrafluoroethylene (PTFE) and a porous PTFE ring-shaped layer which has been sintered to form innumerable pores. The incorporation of a sintered porous PTFE ring-shaped layer which is more readily deformed than sintered [nonporous] PTFE in this ring-shaped sealing material allows the material to deform in a manner befitting the stress to which it is subjected. However, since sintered PTFE is hard, it does not conform very well to the contours of the surface in contact with the sealing material in the area to be tightened (tightening surface), resulting in the inability to achieve satisfactory sealing performance in the absence of insufficiently increased tightening torque, with leakage in the boundary between the tightening surface and the sealing material (interfacial leakage).

Sealing materials featuring the use of laminates of expanded porous polytetrafluoroethylene (ePTFE) have been the subject of scrutiny as PTFE sealing materials permitting better seals at more moderate tightening force on tightening surfaces. The ePTFE ring-shaped sealing material disclosed in Japanese Laid-Open Utility Model Application 3-89133, for example, is obtained when an ePTFE film laminate comprising ePTFE films unified by lamination to a predetermined thickness is punched into the form of a ring. Laminates of ePTFE film are softer than sintered PTFE or composites of sintered PTFE and sintered porous PTFE, and are deformable in the thickness direction of the sealing material, resulting in better adhesion and seals on tightened surfaces.

However, methods where such products are produced by punching film laminates are uneconomical because, as shown in FIG. 14, the parts 3 that are left over after the ring-shaped material 2 has been punched out of the film laminate 1 comprising laminated ePTFE films la have no use and are simply discarded.

In addition to ring-shaped sealing materials, such materials also come in the form of rods and tape. These are ePTFE sealing materials which are obtained when PTFE is extrusion molded into the shape of a rod, as depicted in FIG. 15(a) or tape, as shown in FIG. 15(b), and then uniaxially expanded. Since such sealing materials are attached to tightened areas in such a way as to conform to the shape of the intended area, they are suitable for parts having complex configurations or for limited production of diversified products. However, such rod-shaped and tape products are expanded only in the longitudinal direction, which results in better longitudinal strength but less satisfactory strength in the transverse direction. Such products are therefore susceptible to creep (cold flow) in the transverse direction, that is, the radial direction of the sealing material when in the form of a closed ring. Creep results in a gradual loss of tightening pressure, leading to the inability to preserve high sealing performance. Another problem is that the porous structure of ePTFE can result in leakage at lower levels of tightening force because fluids can pass through the seal material itself as a result of high fluid pressure (penetration leakage).

In addition to the tape in FIG. 15(b), another example of a sealing material in the form of tape has been disclosed in U.S. Pat. No. 5,964,465, where a laminated sheet of biaxially oriented ePTFE film, as illustrated in FIG. 16, is slit to a predetermined width to produce the sealing material in the form of tape. In FIG. 16, 5 is a laminate of ePTFE films, 6 is an adhesive component affixed or applied to one of the laminated surfaces of the film, and 7 is release paper affixed to the adhesive component 6. To use such a sealing material in the form of tape, the release paper 7 is first peeled off, the adhesive component 6 is attached to the tightening surface and wrapped around to conform to the area while affixed thereto, and the beginning and end in the longitudinal direction of the sealing tape are joined to form a ring. FIG. 17 illustrates a sealing material 9 comprising a sealing tape in the form of a closed ring affixed to piping flanges 8.

Sealing materials featuring the use of biaxially expanded film has strength in both the longitudinal direction, that is, the peripheral direction of a sealing material in the form of a closed ring, as well as in the transverse direction (direction in which fluids leak), that is, the radial direction of a sealing material in the form of a closed ring. A problem with the sealing performance, however, is that the direction in which the ePTFE film is laminated is aligned with the axial direction of the pipe, that is, the laminated surface of the ePTFE film is parallel to the direction of leakage, resulting in penetration leakage at high fluid pressures in the case of lower tightening pressure.

A sealing material in the form of a ring, which comprises ePTFE films spirally wound a predetermined number of times, has been disclosed in Japanese Examined Patent Application (Kokoku) 11-51192 as a ring-shaped sealing material which reduces penetration leakage and which can be produced without wasting material. The structure of this material involves ePTFE films la (FIG. 18) laminated in the radial direction of the ring, that is, the direction in which fluid leakage is inhibited, so that layers 10, which comprise suitable compact ePTFE films or the like, can be interposed between ePTFE films la, thereby preventing penetrating leakage to a far greater degree.

However, the shapes of ring-shaped sealing materials formed by such spirally wound lamination are limited to the shape of the mandrels that are used in their manufacture, and it is therefore necessary to equip manufacturing plants with mandrels of varying size and shape according to the intended application, resulting in higher production costs. Furthermore, sealing materials suitable for the complex configurations required in housings of various industrial machines which are not cylindrical can be difficult to produce by such spiral lamination, even with the use of mandrels in the corresponding shape. Also, in the case of ring-shaped sealing materials comprising ePTFE film laminate materials, unsintered ePTFE films are first laminated, the laminate is then sintered, and the unsintered ePTFE films are adhesively unified by compression through the centrally-directed component of force of the contracting force of the film during sintering, making it virtually impossible to produce sealing materials in shapes other than that of a ring. Since a laminated thickness (corresponding to ½ the difference between the outside and inside diameters of the ring-shaped sealing material) over about 10 mm interferes with sufficient sintering of the interior, ring-shaped materials which can be produced by such spirally wound lamination are limited to a width of substantially no more than 10 mm. As the diameter of the mandrel used in the manufacture furthermore determines the inside diameter of the ring-shaped sealing material, mandrels with an outside diameter of no more than 300 mm are normally used. However, the film shrinkage that takes place during sintering at that size results in considerable rolled compactness and thus in considerable density, with less conformability to the tightening surface.

### SUMMARY OF THE INVENTION

This invention provides a sealing material comprising a tape comprising a laminate having a height and a width and comprising a plurality of expanded porous polytetrafluoroethylene films, wherein the height of the laminate is greater than the width of the laminate. The laminate has end faces along the height and the end faces are adapted to contact tightened surfaces of a vessel to be sealed. An adhesive component is preferably applied to at least one end face of the laminate. Release paper may be applied to the adhesive component. The sealing material may comprise a plurality of laminates. In such case, the laminates are joined by being thermally fused using a tetrafluoroethylene-hexafluoropropylene copolymer film or tetrafluoroethylene-perfluoroalkyl vinyl ether copolymer film. At least one layer for preventing fluid penetration is preferably interposed in the laminate. The layer for preventing fluid penetration preferably comprises a fluororesin film, such as a compact polytetrafluoroethylene film (wherein the compact polytetrafluoroethylene film comprises an expanded porous polytetrafluoroethylene in which the pores have been crushed flat under pressure). The layer for preventing fluid penetration may also be an elastomer such as Sifel®. The laminate of this invention is preferably adhesively unified through sintering of the expanded porous polytetrafluoroethylene films. The tape of the invention may be joined at the longitudinal beginning and end to form a closed ring, wherein the direction in which the laminated strips have been laminated is the radial direction of the closed ring. The beginning and end are preferably joined by adhesion with double sided adhesive tape.

In another aspect, the invention provides a method for producing a sealing material in the form of tape, comprising the steps of: laminating a predetermined number of sheets of expanded porous polytetrafluoroethylene film to produce a first laminate; slitting the first laminate to a predetermined width to obtain laminates in the form of strips having a height and a width, the height being greater than the width, with end faces along the height; and affixing or applying an adhesive to the end faces.

### BRIEF DESCRIPTION OF THE FIGURES

FIG. 1 illustrates the structure of a sealing material in the form of tape in a first embodiment of the present invention.

FIG. 2 illustrates the way in which the sealing tape in FIG. 1 is used.

FIG. 3 illustrates the way in which a sealing material in the form of a closed ring is used in the present invention.

FIG. 4 illustrates the action of the sealing tape in the present invention.

FIG. 5 illustrates the sealing tape when provided with an adhesive component.

FIG. 6 illustrates another embodiment of the adhesive components in the sealing tape of the present invention.

FIG. 7 illustrates another embodiment of the adhesive components in the sealing tape of the present invention.

FIG. 8 illustrates the way in which the beginning and end of the sealing tape in the present invention is joined.

FIG. 9 illustrates a method for producing the sealing tape in the present invention.

FIG. 10 illustrates the joined type of sealing tape in the present invention.

FIG. 11 illustrates a method for producing the sealing tape of the present invention.

FIG. 12 illustrates an embodiment of the sealing tape of the present invention with a fluid penetration-preventing layer.

FIG. 13 illustrates the measurement of the amount of leakage used in the examples.

FIG. 14 illustrates problems in conventional sealing materials.

FIG. 15(a) illustrates a conventional rod-shaped sealing material, and 16(b) illustrates a conventional sealing material in the form of tape.

FIG. 16 illustrates a conventional film laminated type of sealing material in the form of tape.

FIG. 17 illustrates problems in the conventional film laminated type of sealing material in the form of tape.

FIG. 18 illustrates a conventional ring-shaped sealing material.

### DETAILED DESCRIPTION OF THE INVENTION

In view of the foregoing, an object of the present invention is to provide a PTFE sealing material in the form of tape, which is suitable for tightening surfaces of complex and varied configuration, and which permits less penetration leakage.

The sealing material in the form of tape in the present invention comprises expanded porous polytetrafluoroethylene film laminated into a laminate in the form of a strip, wherein the laminated height of the laminated strip is greater than the width. The laminated end faces on the long side of the laminated strip should be in contact with the tightening surface.

The sealing material in the form of tape in the present invention may have an adhesive component applied to at least one laminated end face on the long side of the strip of laminate. Release paper may be affixed to the adhesive component.

A plurality of laminate strips may be integrally joined together at the laminated surfaces of the laminate. In such cases, the laminated parts should be joined by being thermally fused using a tetrafluoroethylene-hexafluoropropylene copolymer film or tetrafluoroethylene-perfluoroalkyl vinyl ether copolymer film. An adhesive component may be provided on at least one side of the laminated end face on the long side.

At least one layer for preventing fluid penetration should be interposed in the laminate strip or joined laminates, and the layer for preventing fluid penetration should be a fluororesin film, preferably compact polytetrafluoroethylene film. The compact polytetrafluoroethylene film should comprise an expanded porous polytetrafluoroethylene in which the pores have been crushed flat under pressure. In an alternative embodiment, the fluid penetration layer is an elastomeric material. An exemplary elastomeric materials is Sifel®.

The laminate should be adhesively unified through sintering of the expanded porous polytetrafluoroethylene films.

The sealing material in the form of a closed ring in the present invention comprises the aforementioned sealing material in the form of tape which has been joined at the longitudinal beginning and end, wherein the direction in which the laminated strips have been laminated is the radial direction of the closed ring.

The beginning and end of the sealing material in the form of a closed ring may be joined by adhesion with double sided adhesive tape.

A manufacturing method in the present invention comprises the steps of: laminating a predetermined number of sheets of expanded porous polytetrafluoroethylene film to produce a first laminate; slitting the first laminate to a predetermined width to obtain laminates in the form of strips; and affixing or applying an adhesive to the laminated end faces on the long side of the laminate strips.

The first laminate should comprise cutting and spreading out an expanded porous polytetrafluoroethylene film laminated in the form of a cylinder, which has been obtained by being wrapped around a mandrel.

During the manufacture of a sealing material in the form of tape with a layer for preventing fluid penetration interposed therein, a compact polytetrafluoroethylene film should be interposed in the first laminate, wherein the compact polytetrafluoroethylene film should comprise a wrapped expanded porous polytetrafluoroethylene film in which the pores have been crushed flat under pressure.

The manufacturing method in the present invention should comprise a step for sintering the first laminate after the step for producing the first laminate and before the step for slitting it to a predetermined width.

Embodiments of the invention are illustrated below with figures.

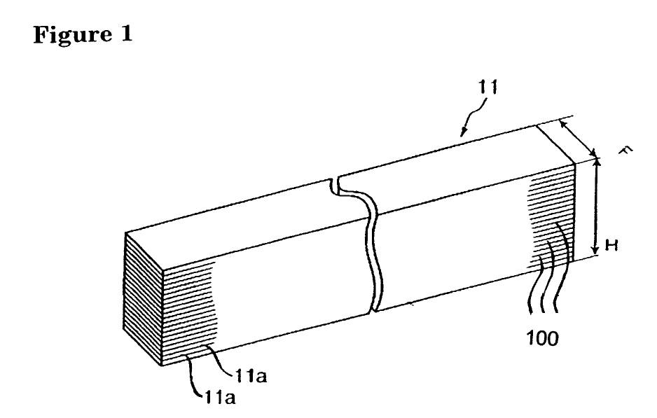

FIG. 1 is an oblique view of an embodiment of a sealing material in the form of tape in the present invention. The sealing material in the form of tape comprises strips of expanded porous polytetrafluoroethylene (ePTFE) film 11a laminated into a laminate strip 11, characterized in that the laminated height (H) of the laminated strip 11 is greater than the width (F) of the laminated strip 11. In other words, the cross section in the transverse direction of the laminated strip 11 is rectangular, where the short side corresponds to the width (F) of the laminate strip, and the long side corresponds to the laminated height (H).

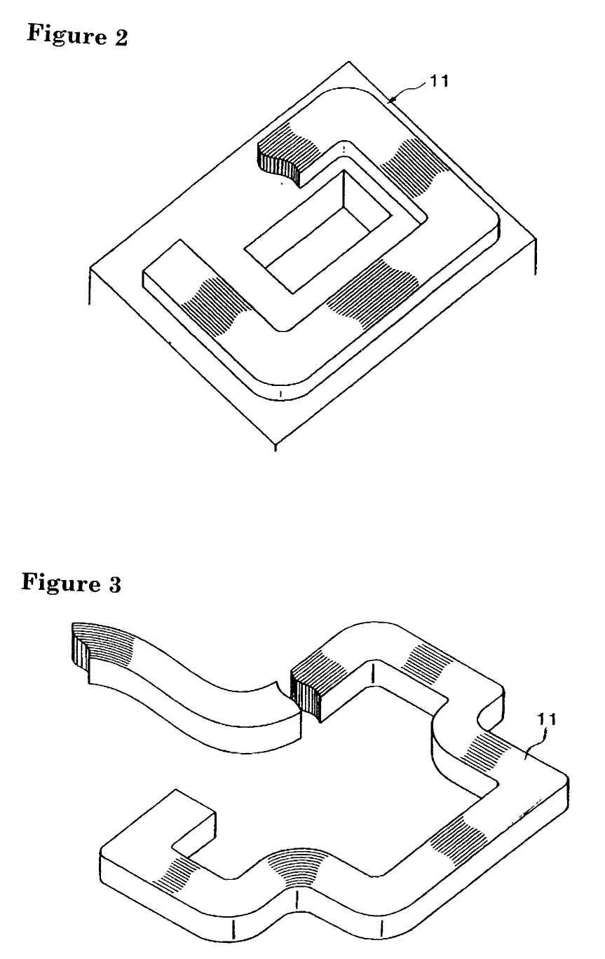

As shown in FIG. 2, such a sealing material in the form of tape is used in the form of a closed ring, where the laminated end faces on the long side of the ePTFE film strip laminate 11 (that is, the face where the edge on the long side of the film 11a is formed by the lamination) as shown in FIG. 2 are in contact with the tightening surface. As such, the sealing material in the form of tape in the present invention may be a laminate strip in which films 11a are laminated so that the laminated height H is greater than the width (F) of the films 11a, but the laminated end faces 100 on the long side of the laminated strip should face the tightening surface. That is, in use, the laminate 11 is used on its side as shown in FIG. 2, 90° from how it is produced (as shown in FIG. 1). The long side (corresponding to the laminated height H) should be about 1 to 50 times, and preferably about 3 to 10 times, greater than the short side (corresponding to the width F of the laminated strip). This will allow the user to readily discern that the seal should be used with laminated end faces 100 on the long side facing the tightening surface.

The softness of the sealing tape in the present invention is based on the properties of the ePTFE film laminate, and can thus be applied sequentially to tightening surfaces such as those with the complex configuration illustrated in FIG. 3, for example, to form a seal in the form of a closed ring conforming to the shape of the area where a seal is desired. The flexibility is thus a feature of the softness which can be traced to the properties of the ePTFE. A closed ring can be formed adhering to tightened parts and housings having complex shapes other than round or angled shapes, allowing the sealing tape of the present invention to be used to effectively seal such components having complex shapes.

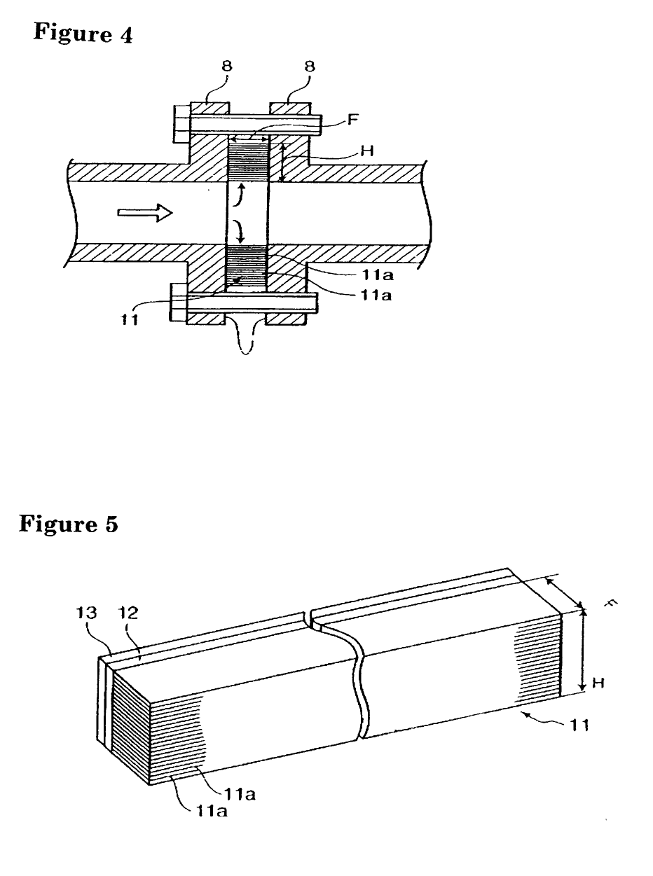

FIG. 4 illustrates a case in which the longitudinal beginning and end of an ePTFE film laminate strip 11 forming the sealing tape in the present embodiment are joined to form a seal in the form of a closed ring, which is applied to the tightening portions of flanges 8. Because the ePTFE films 11a are laminated perpendicular to the direction in which fluids leak, layers for preventing fluid penetration can be interposed between the layers of the laminate so as to suppress fluid penetration leakage. The flexibility of the ePTFE film laminate 11 results in good conformability to the contours of the tightening surfaces of the flanges 8 and 8, permits good sealing properties at lower tightening torque, and can prevent interfacial leakage. The laminated height of the seal tape corresponding to the thickness of the closed ring seal (corresponding to ½ the difference between the outside and inside diameters) can be adjusted by the number of ePTFE films 11a that are laminated in the laminated strip 11 and by the extent to which laminated strips are joined, so that closed ring seals of varying thickness can be formed according to the desired seal performance.

The ePTFE films 11a should be at least 20 μm, and preferably 50 μm thick, but no more than 500 μm, and preferably no more than 150 μm. A thickness over 500 μm will result in lamination defects, while less than 20 μm will make the film difficult to handle and will result in lower productivity because of the need for greater numbers of film layers to produce a seal tape of the desired width.

Such ePTFE films are obtained by mixing PTFE fine powder with a molding aid to form a paste, extracting the molding aid from the resulting paste molding, expanding the molding at elevated temperature and speed, and then sintering the product as needed. Uniaxial expansion results in nodes (folded crystals) in the shape of narrow islands at right angles to the stretching direction, which are linked by slatted fibrils (linear molecular bundles which are broken down and drawn out as the folded crystals are stretched) oriented in the stretching direction. In the resulting fibrillated structure, pores are formed between the fibrils or in the spaces between the fibrils and nodes. Biaxial expansion results in the radial expansion of fibrils, with scattered island-shaped nodes linking the fibrils, giving a webbed fibrillated structure with numerous spaces between the fibrils and nodes.

The ePTFE films 11a serving as the constituent material of the seal tape in the present invention may be either uniaxially expanded ePTFE film or biaxially expanded ePTFE film, but biaxially expanded ePTFE film is preferred. When used in the form of a closed ring seal, tensile stress acts in the peripheral direction of the closed ring seal due to internal pressure (fluid pressure), so the seal tape will require longitudinal strength to withstand this stress. To suppress creep (cold flow) caused by tightening force, the seal tape will also require strength in the thicknesswise direction (corresponding to the widthwise direction of the laminated strip). Biaxially expanded ePTFE films will enjoy both.

The mean pore diameter of the PTFE films forming the seal tape in the present invention can be adjusted by the draw ratio, but is preferably between 0.05 and 5.0 microns, and even more preferably between 0.5 and 1.0 microns. Pores that are too large will result in lower contact surface area between films, lower adhesion between films, and lower seal performance as a result of penetration leakage. A mean pore diameter of less than 0.05 microns, on the other hand, is difficult to engineer.

The porosity of the ePTFE film forming the seal tape of the present invention can be adjusted to between 10 and 95% according to the draw ratio, but should be selected within the range of 30 to 85% according to the conditions of use (surface roughness of the tightening surface, tightening force, etc.). A greater porosity will result in greater flexibility, allowing a better seal to be achieved on rough surfaces with lower tightening force, but the chances of penetration leakage will also increase.

The laminate strip 11 comprising such ePTFE films 11a should be sintered after the unsintered ePTFE has been laminated to form the laminate strip 11. Such sintering of the laminate will improve the adhesion sufficiently to unify the ePTFE films.

Because the laminated height (H) of the laminate strip in the sealing tape of the present invention is greater than the width (F) of the laminate strip, and because of the flexibility of the ePTFE film, the longitudinal beginning and end of the sealing tape can be readily joined as the laminated end faces are in contact with the tightening surface. An adhesive component should be provided on one of the laminated end faces. A closed ring can be formed conforming to the seal area as the adhesive component is affixed to the tightening area, making it easier to form a closed ring having a more complex shape.

FIG. 5 illustrates a sealing tape in which an adhesive component 12 is provided on one of the laminated end faces on the long side of the laminate strip 11, with release paper 13 affixed to the adhesive component 12.

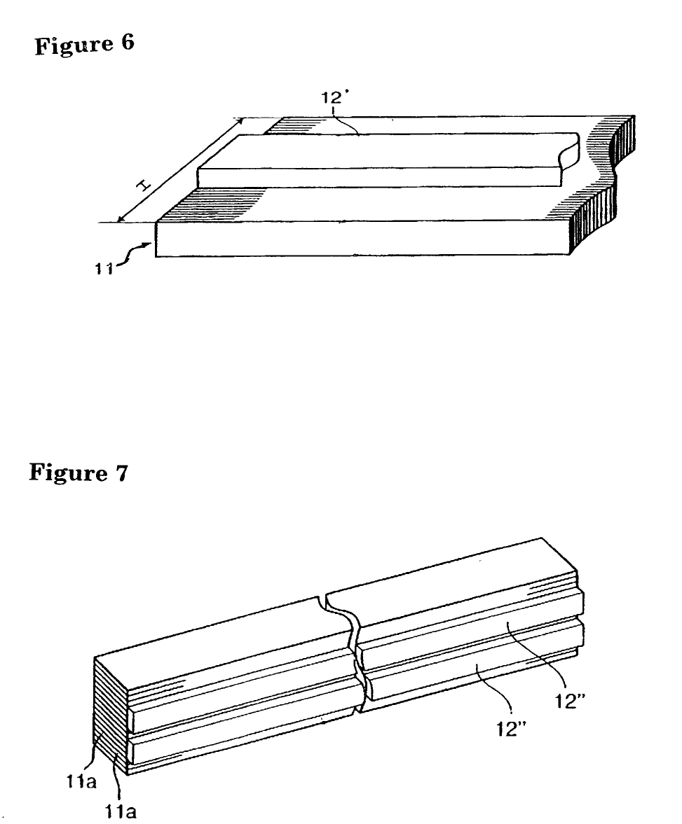

The adhesive component 12 may be formed by affixing or applying an adhesive to the entire laminated end face on the long side of the laminate strip 11, as shown in FIG. 5, an adhesive component 12′ narrower than the width of the laminated strip 11 may be provided along the longitudinal direction around the center of the laminated end face on the long side of the laminated strip 11, as illustrated in FIG. 6, or a plurality of narrow adhesive components 12″ may be provided parallel to each other in the longitudinal direction at predetermined intervals on the laminated end face on the long side, as illustrated in FIG. 7. The adhesive component 12 may be provided on the laminated end faces on either one side or both sides of the ePTFE laminated strip 11.

In an ideal embodiment, the width of the adhesive component in about the center of the laminated end face on the long side will be narrower than the laminated height H, as illustrated in FIG. 6. When the adhesive component is provided on the entire surface of the laminated end face, the adhesive component can come into contact with fluids when used in the form of a closed ring, and the heat resistance and chemical resistance of the adhesive will thus affect the seal performance. The adhesive components 12′ and 12″ provided in only a portion of the laminated end faces as illustrate din FIGS. 6 and 7 are sufficient for adhesion to the tightening area and will not come into contact with fluids when tightened. In the embodiment depicted in FIG. 6, the width of the adhesive component 12′ should be ⅔ to 1/10, and preferably ½ to ¼, the laminated height of the sealing tape. Less than 1/10 will not permit enough adhesion to allow the seal to readily adhere.

Conventional adhesives such as acrylic or rubber types can be used as the adhesive for the adhesive component 12 (or 12′ or 12″), but acrylic adhesives are preferred for their excellent heat resistance. Liquid adhesives may be applied and adhesive sheets may be affixed, but double sided adhesive tape laminated with release paper 13 is preferred. Double-sided adhesive tape is readily attached to laminated strips 11 during the tape manufacturing process, and allows the sealing tape to be readily attached once the release paper 13 has been removed to permit the tape to be attached to the tightening area. Double-sided tape with no substrate is preferred for the sake of sealing performance.

The adhesive component 12 should be 3 to 200 μm thick, and preferably 5 to 25 μm. Less than 3 μm will not permit satisfactory adhesion, while more than 200 μm will mean that the effect of the properties such as the heat resistance and chemical resistance of the adhesive on the sealing tape can result in poor sealing performance.

The release paper 13 is provided to protect the adhesive component 12 and is peeled off before use. Any material in the form of a sheet with release properties may be used as the release paper, but preferred examples include paper coated or impregnated with a silicone resin, fluororesin or other release agent; resin films with exceptional release properties, such as polyethylene film or polypropylene film; or films of polyester, polyimide, or the like which are coated on the surface with a release agent such as a silicone resin or fluororesin.

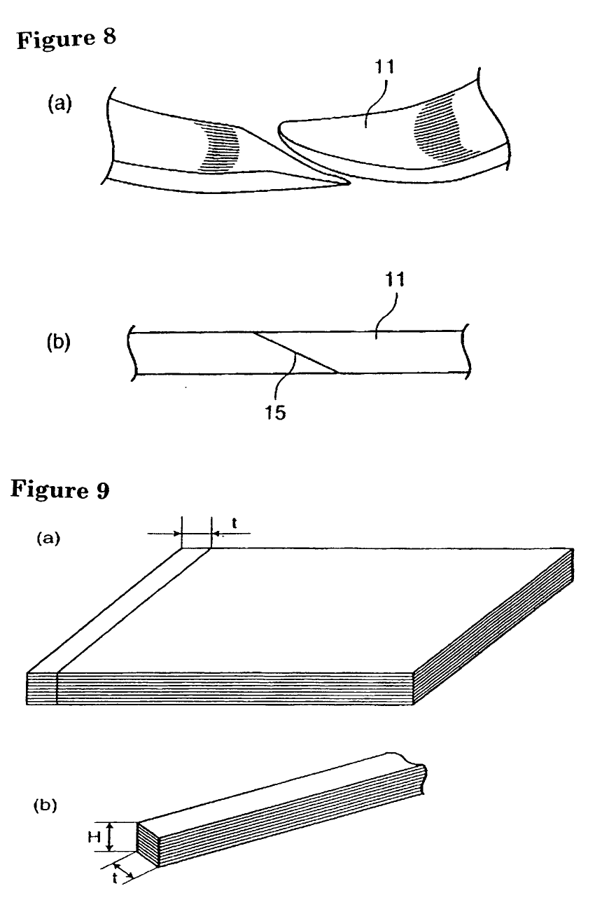

The method for joining the beginning and end of the laminated strip 11 to form a closed ring is not particularly limited. As illustrated in FIG. 8, the beginning and end of the laminated strip 11 are preferably joined by cutting them in tapered form (FIG. (8a)) and allowing the tapered surfaces to overlap one another (FIG. 8(b)). Although the part where they are joined 15 can be unified and joined by the tightening pressure, they may also be joined with the application of an adhesive or the use of double-sided adhesive tape at the surfaces where they are joined. The tapered surfaces of the beginning and end need not be perfectly fitted to each other. The beginning (or end) of the laminated strip 11 may overlap so as to ride up on the end (or beginning) of the laminated strip 11, and the part that rides up will be leveled by the tightening force if there are no gaps in the overlapped section. The thickness of the overlapped section when one end rides up over the other should be no more than 1.5 times, and preferably no more than 1.3 times, the thickness of the laminated strip. An overlapping thickness greater than 1.5 times the original thickness will result in too great a difference in levels, and will tend to result in a gap in the joined section, which will be susceptible to interfacial leakage.

The method for producing the ePTFE sealing tape of the present invention is not particularly limited, although the following method is preferred. First, a predetermined number of ePTFE films is laminated to form a laminate in the form of a sheet to a given laminated height H (corresponding to the first laminate in claim 15) (FIG. 9(a)). The laminated sheet is slit to a predetermined width t, giving a laminate strip (FIG. 9(b)). When an adhesive component is included, an adhesive should be affixed or applied to the slit surface of the laminate strip (laminated end face on the long side) to form the adhesive component. The result is a sealing material in the form of tape with a laminated height H and laminate strip width corresponding to the slit width t.

The laminated sheet does not have to be slit parallel to the laminated end faces, but can also be cut diagonally or helically to obtain a longer laminate strip.

Before being slit, the laminated sheet should be sintered to improve the adhesion between the ePTFE films.

The number of layers of ePTFE films laminated in the laminated sheet should be selected according to the laminated height of the sealing tape and the thickness of the ePTFE films, but the laminated height of one laminate will preferably be no greater than 10 mm for the sake of the adhesion brought about through the sintering process. More than 10 mm will not permit the interior of the laminate to be sufficiently sintered in ordinary air heating processes, with a resulting loss of film adhesion in the interior and the chance of breakage when tightened. A heating method involving the use of a salt bath will permit sufficient sintering even with a laminated height over 10 mm, so in that case the laminated height is not particularly limited for the sake of sintering adhesion.

However, a plurality of laminate strips 11 with a laminated height of about 10 mm should be joined in the laminated direction when it is desirable to obtain a thick sealing tape in which the laminated height corresponding to the thickness of the closed ring seal (corresponding to ½ the difference between the outside and inside diameters) is more than 10 mm. FIG. 10 illustrates sealing tape in which three laminates strips 11 are unified at the laminated surfaces, resulting in a laminated height that is three times greater.

The method for joining laminate strips can be any allowing such strips to be joined, but examples of preferred methods include methods in which an adhesive, self-adhesive, or the like is applied to the laminated surfaces to join the strips, methods in which laminate strips 11 are thermally fused with plastic film interposed between adjacent strips, and methods in which the laminated surface is heated to beyond the ePTFE melting point for thermal adhesion. Methods featuring the use of plastic film are preferred. FIG. 10 illustrates a laminate strip 11 in which the laminated surfaces are joined together by heat fusion with plastic films 16 interposed therebetween, where 12 is an adhesive component located in about the center of the laminated end faces of the joined laminate, and 13 is release paper.

Fluororesin films with good heat resistance and chemical resistance are preferably used as the plastic film 16, while tetrafluoroethylene-hexafluoropropylene copolymer films (FEP films) or tetrafluoroethylene-perfluoroalkyl vinyl ether copolymer films (PFA films) are even more desirable. Plastic film 16 is preferably used to join the laminates because they are effective layers for preventing fluid penetration when the sealing tape made up of the joined laminate is made into a closed ring, as described below.

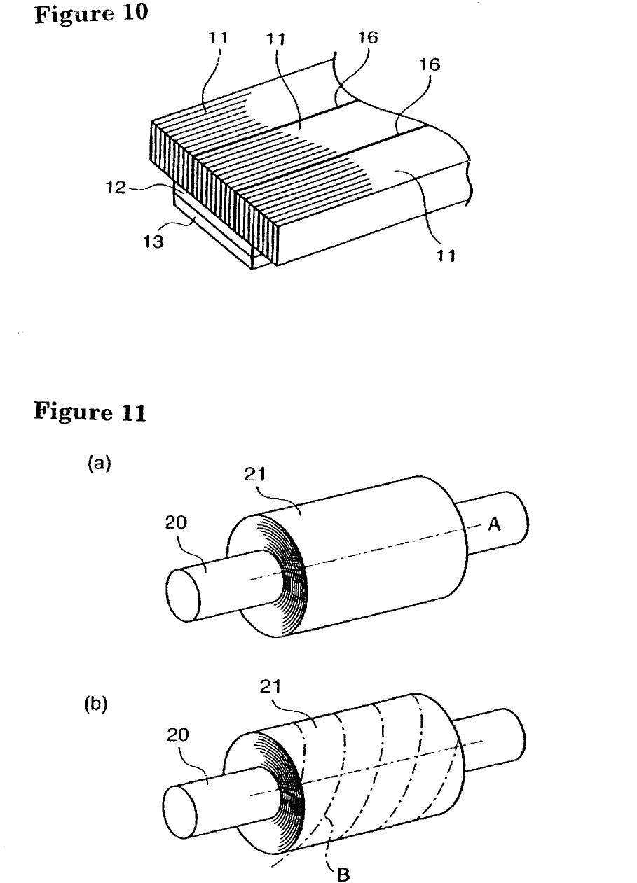

The joined laminate strip illustrated in FIG. 10 may be formed by directly joining a plurality of laminate strips 11, 11, etc., but it is also possible to first form a laminate in the form of a flat sheet by superposing the laminated surfaces of laminate flat sheets to a laminated height of 2, 3, or more times, and to then slit the resulting laminate to a predetermined width t. Although the method for producing a laminate in the form of a flat film with ePTFE film is not particularly limited, ePTFE film can be wrapped around a mandrel 20 as shown in FIG. 11 to produce an ePTFE film laminate in the form of a cylinder 21, which may then be cut at a single location ((dot-chain line A in FIG. 11(a)) to spread out the laminated cylinder 21, thereby giving a large laminate in the form of a flat sheet, or which may be cut spirally along the periphery of the laminated cylinder 21 (the dot-chain line B in FIG. 11 (b)), thereby giving a continuous laminate strip. When a laminate strip is formed form a laminated cylinder, the sintering may be managed after the cutting results in a laminate in the form of a flat sheet or a laminate in the form of a strip, but it is better to sinter the laminated cylinder 21 along with the mandrel because of more convenient handling and because the rolled compactness during sintering will facilitate the adhesive unification of the ePTFE films.

Although the shape, size, and composition of the mandrel 20 are not particularly limited, cylinders of large diameter are preferred so the film can be cut into large laminates in the form of flat sheet or continuous laminate strips. In the interests of sintering films along with the mandrel 20, a material that will prove to be heat resistant during sintering is preferred, such as iron or stainless steel.

The ePTFE film laminate should be sintered at or beyond the melting point of polytetrafluoroethylene, specifically, 327° C., and preferably between 350° C. and no higher than 380° C., preferably no higher than 365° C. The sintering will allow the ePTFE films to be fused together and unified so that the overlapping sections will become virtually indistinguishable. Sintering over 380° C. will result in the thermal deterioration of the PTFE resin, causing holes to appear in the ePTFE film laminate.

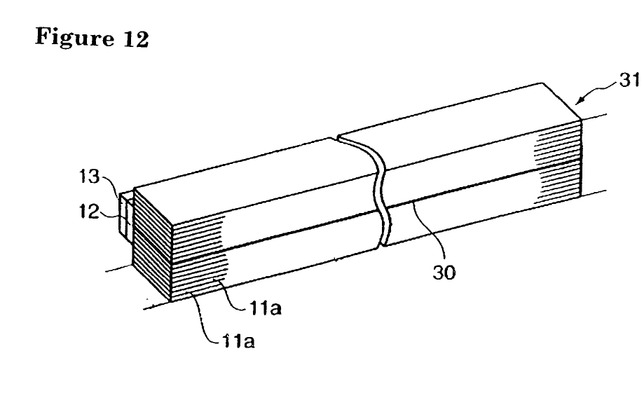

The second embodiment of the sealing material in the form of tape in the present invention is provided with a layer to prevent fluid penetration. FIG. 12 illustrates sealing material in the form of a tape, where the laminated structure of the ePTFE films comprises an adhesive component 12 laminated to the laminated end faces on the long side of a laminate strip 31, with release paper 13 provided on the adhesive component 12.

The layer for preventing fluid penetration 30 is a layer that prevents fluids from penetrating from the outside through the ePTFE films that form the sealing material, and is made of a material that does not have any pores through which fluids might otherwise penetrate. The layer for preventing fluid penetration 30 prevents the kind of penetration leakage that occurs through ePTFE films which have been laminated perpendicular to the direction of fluid leaks.

Examples of structural materials for such fluid leak-preventing layers 30 include fluororesins such as PTFE, FEP, and PFA, rubber such as silicone rubber, and metals, which should be selected according to the environment in which the seal material will be used (particularly the types of fluid flowing through the pipe), method used to manufacture the sealing material (particularly the presence or absence of sintering), the intended properties, and so forth. When a corrosive fluid is to be sealed off, for example, a compact PTFE film with good corrosion resistance should be used, whereas a metal film strip (metal foil) may be used in cases of high pressure fluids. Examples of compact PTFE films include films made of sintered PTFE and films made of one or more ePTFE films which have been placed on top of each other, with the pores in the ePTFE subsequently crushed flat. Compact PTFE films in which the pores of the ePTFE have been crushed flat are those in which the pores have been crushed flat while preserving the ePTFE fiber orientation, giving films that are thinner than sintered PTFE films and that have greater strength, which are thus suitable as structural material for fluid penetration-preventing layers 30 requiring flexibility.

The fluid penetration-preventing layer 30 may be a single film or strip of foil, and may also be a plurality of films which have been unified by lamination. Ultimately, the film forming the layer 30 for preventing the penetration of fluids should be of a thickness that does not adversely affect the flexibility of the sealing tape, and should be thick enough to ensure adhesion with the ePTFE films 11a which constitute the sealing tape. Although the thickness of the layer 30 for preventing fluid penetration will thus vary depending on the type of structural material used for the layer to prevent fluid penetration, it should be 5 μm, and preferably at least 15 μm, but no more than 300 μm, and preferably no more than 100 μm.

When the layer 30 for preventing fluid penetration is made of a resin other than PTFE, such a layer 30 can be formed by allowing a hot melt resin to cool to solidification or by heating and curing an emulsion solution or high viscosity liquid such as a heat cured resin which has been cured to the B stage. In such cases, the thickness of the layer 30 will be limited to the range within which such materials can be applied in view of the manufacturing method.

The location of the layer 30 for preventing fluid penetration is not particularly limited. Although only one such layer 30 is provided in the sealing material illustrated in FIG. 12, a plurality of such layers for preventing fluid penetration can be provided in the sealing tape of the present invention. A separate fluid penetration-preventing layer 30 provided on the outer periphery can keep fluids from leaking out in cases such as those where fluids have penetrated through the fluid penetration-preventing layer 30 on the side near the inner periphery in closed ring sealing materials made with sealing tape incorporating a plurality of fluid penetration-preventing layers. The greater the number of such layers for preventing fluid penetration, the better the sealing performance.

In the second embodiment, an adhesive component 12 and release paper 13 may be provided in the same manner as in the first embodiment, and will thus not be described again.

In sealing tape provided with layers 30 to prevent fluid penetration, the film or foil forming the layer should be interposed during the process for producing the ePTFE film laminate in order to manufacture an ePTFE film laminate with such layers interposed. In cases where the fluid penetration-preventing layer is a compact PTFE film comprising an ePTFE film in which the pores have been crushed, produced by wrapping the ePTFE film laminate around a mandrel, the ePTFE film should be wrapped around the mandrel, and said ePTFE film should be pressed by a calendering roll or the like as it is wrapped, so as to crush the pores, thereby converting the ePTFE film to a compact PTFE film. Greater productivity can be achieved because such a procedure allows fluid penetration-preventing layers to be automatically interposed during continuous wrapping. The ePTFE film lamination process and the compact PTFE film wrapping process may of course also be discontinuous, so that ePTFE film can be wrapped the predetermined number of times, the beginning of a compact PTFE film can be adhesively attached to the end of the wrap and wrapped, and the beginning of another ePTFE film can be attached to the end of the compact PTFE film to again wrap ePTFE film.

When the fluid penetration-preventing layer 30 is formed by curing a high viscosity liquid or solution, or by allowing a hot melt resin to cool to solidification, an ePTFE film strip which has been pre-laminated or pre-coated with a material forming such a fluid penetration-preventing layer should be wrapped during the process for wrapping the ePTFE film strip. A coater or the like can be used to apply the material forming the fluid prevention layer at the location on the ePTFE film strip corresponding to the location where the fluid prevention layer is to be provided, so as to facilitate the resin coating procedure for forming such layers in order to produce ring-shaped sealing materials with fluid prevention layers provided at suitable locations. When the material forming the fluid prevention layer does not permit sintering at elevated temperatures, the adhesion of the ePTFE film is usually dependent on the adhesive. When ePTFE film strips are adhesively laminated with an adhesive, ePTFE films strips which have been pre-coated with an adhesive should are preferably wrapped.

### EXAMPLES

The present invention is illustrated in the specific examples below.

Preparation of ePTFE Film

A resin paste comprising 22 weight parts solvent naphtha blended per 100 weight parts emulsion polymerized polytetrafluoroethylene powder (fine powder) was formed into a film, the resulting paste molding in the form of a film was heated to the boiling point of the solvent naphtha to allow the solvent naphtha to evaporate off, and the film was then biaxially expanded at a rate of at least 10% per second at a temperature below the melting point of the polytetrafluoroethylene to produce a 60 μm thick ePTFE film with a porosity of 80%.

Preparation of Sealing Material in the Form of Tape

### (1) Example 1

The ePTFE film prepared above was wrapped around a hollow stainless steel mandrel 1000 mm in diameter and 1500 mm long. It was wrapped 110 times, the ends of the film were then cut with a cutter, and the film was secured with double-sided adhesive tape in the form of a laminated cylinder, so that the cut ends of the ePTFE film could not turn over.

Meanwhile, three ePTFE films were placed on top of each other, and pressure was applied while heated to crush the pores, giving a 50 μm thick compact ePTFE film.

The resulting compact ePTFE film was wrapped around the laminated film cylinder produced above, and the cut ends were secured with double-sided adhesive tape. ePTFE film was then wrapped again 110 times, and the cut ends were secured with double-sided adhesive tape.

The laminated ePTFE film cylinder with the liquid penetration-preventing layer interposed therein was placed in an oven and sintered for 60 minutes at 365° C. The cylinder was then taken out of the oven and allowed to cool to room temperature.

After the cylinder had cooled, the portions secured with the double-sided adhesive tape were cut open, giving ePTFE film in the form of a flat laminated sheet with a laminated height of 10 mm. The sheet was slit to a width of 2 mm. Double-sided adhesive tape (#9458 by Sumitomo 3 M, 25 μm thick, 3 mm wide) was applied in about the center on one of the laminated end faces on the long side of the resulting narrow laminated strips, giving sealing tape with a laminated height (corresponding to the width of the sealing tape) of 10 mm and a laminated strip width (corresponding to the thickness of the sealing tape) of 2 mm.

### (2) Example 2

An ePTFE film laminate cylinder was produced in the same manner as in Example 1 except that the ePTFE film was wrapped 55 times instead of 110 times. The laminated cylinder was sintered and then cut open, giving a 5 mm thick (laminated height) laminate in the form of a flat sheet. The flat sheet was slit to a width of 1 mm, giving sealing tape with a laminated height (corresponding to the width of the sealing tape) of 5 mm and a laminated strip width (corresponding to the thickness of the sealing tape) of 1 mm.

### (3) Example 3

Two ePTFE films in the form of laminated flat sheets prepared in Example 1 were laminated together at the laminated surfaces using 25 um thick FEP film to form a 20 mm thick (laminated height) ePTFE film in the form of a flat sheet. They were fused for 30 minutes at 300° C.

The flat sheet was slit to a width of 5 mm. Double-sided adhesive tape (#9458 by Sumitomo 3M, 25 μm thick, 3 mm wide) was applied in about the center on the laminated end faces on the long side of the resulting narrow laminated strips, giving sealing tape with a laminated height (corresponding to the width of the sealing tape) of 20 mm and a laminated strip width (corresponding to the thickness of the sealing tape) of 5 mm.

### (4) Comparative Example 1

The comparative example was a sealing material in the form of a uniaxially expanded rod 6 mm in diameter, prepared by the extrusion molding of polytetrafluoroethylene using a circular die.

### (5) Comparative Example 2

The comparative example was a sealing material in the form of a uniaxially expanded rod 3 mm in diameter, prepared by the extrusion molding of polytetrafluoroethylene using a circular die.

### (6) Comparative Example 3

The comparative example was a ring-shaped sealing material obtained by punching rings with an inside diameter of 60 mm and an outside diameter of 80 mm from a commercially available 1.5 mm thick sintered PTFE sheet.

### (7) Comparative Example 4

The comparative example was a sealing material in the form of 5 mm thick and 20 mm wide tape, comprising an ePTFE film laminate. The ePTFE film in this case was laminated in the thicknesswise direction, with a laminated height of 5 mm. The resulting sealing material in the form of tape had an adhesive component provided on the laminated surface of the ePTFE film laminate.

### (8) Comparative Example 5

A film laminate in the form of a cylinder was produced in the same manner as in Example 1 except that the mandrel was a hollow stainless steel mandrel 60 mm in diameter. The film was sintered for 50 minutes at 365° C. and allowed to cool, and the mandrel was then removed, giving a laminated cylinder with an inside diameter of 60 mm and an outside diameter of 70 mm. The laminated cylinder was cut to a width of 5 mm, giving ring-shaped 5 mm thick seals with an inside diameter of 60 mm and an outside diameter of 70 mm. A compact PTFE film layer serving as a layer to prevent the penetration of fluids was interposed at a point 65 mm from the center.

### (9) Comparative Example 6

The ePTFE film used in Example 1 was wrapped 200 times around a mandrel 60 mm in diameter, compact PTFE was then wrapped around it, ePTFE film was again wrapped 200 times around that, and the object was sintered for 50 minutes at 365° C. The mandrel was taken out, but the film could not be cut into rings because of the low adhesion and the separation between films.

Measurement of Amount of Leakage

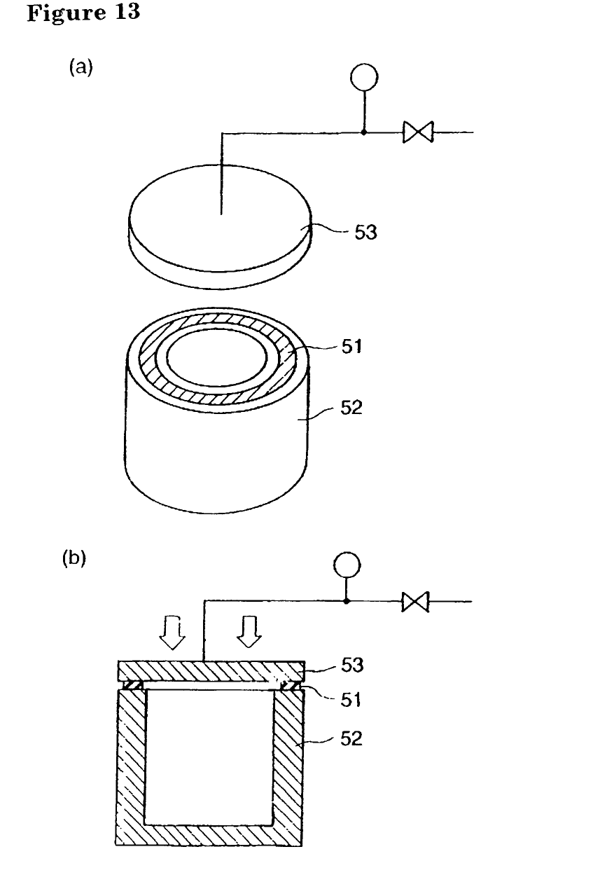

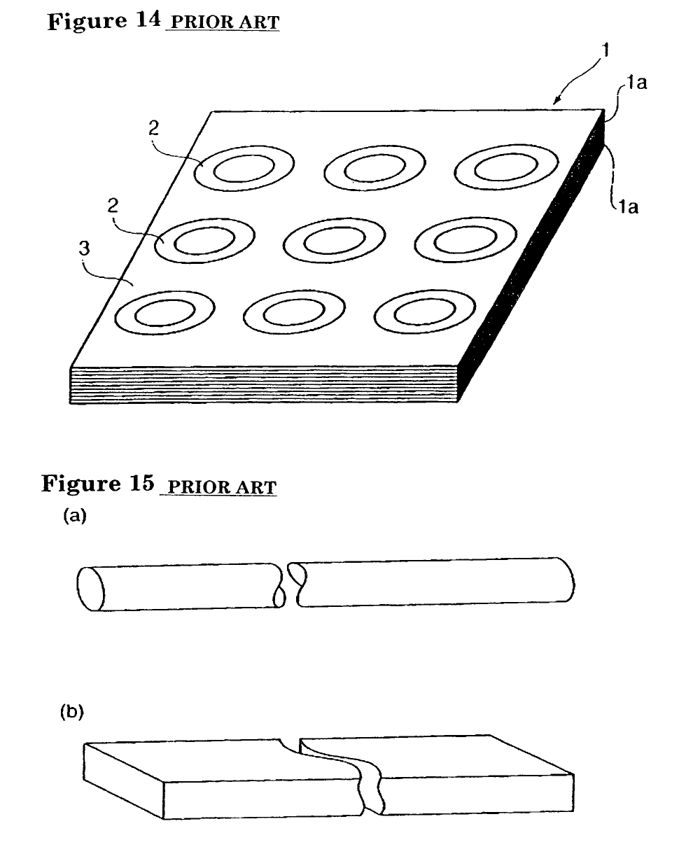

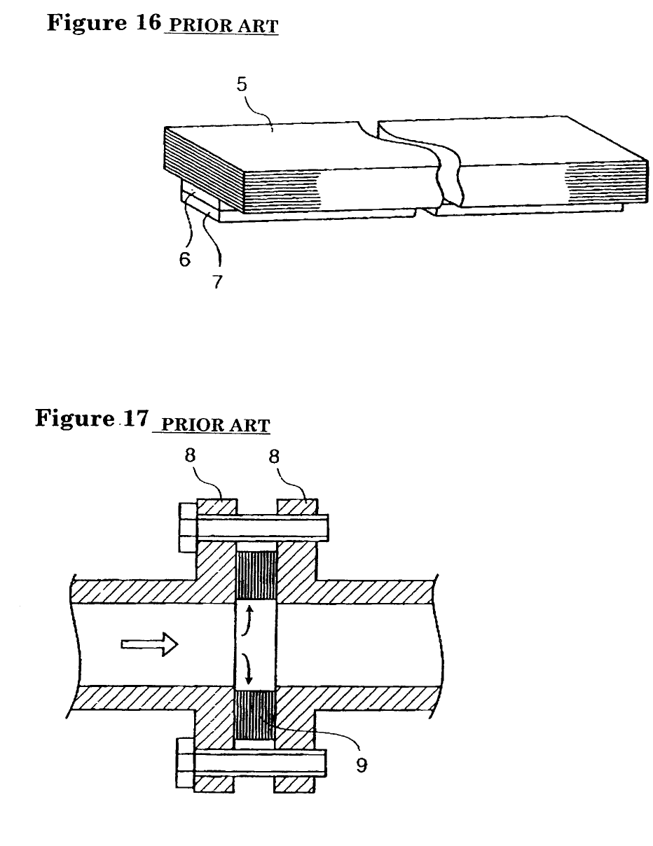

The prepared sealing material 51 was set up in an opening at the top of a bottomed cylinder 52 as shown in FIG. 13(a), and the top opening was covered by a lid 53. With the lid in place (FIG. 13(b)), pressure was gradually increased to the predetermined pressure level, and compressed air was blown in to determine the amount of leakage (Pa-m³/sec) when the internal pressure in the container 52 reached a predetermined pressure. The tightening pressure was adjusted by the load applied to the lid 53. The load was calculated as “sealing material surface are×tightening pressure.” For example, in the case of 1 MPa tightening pressure on sealing material with an inside diameter of 60 mm and an outside diameter of 80 mm, a 2,200 N load was applied. The amount of leakage was determined as P×50/T (units of Pa-m³/sec) by reading the internal pressure of the container 52 with a gauge T seconds after the cock was closed, where P (units of MPa) is the decrease in internal pressure. The 50 in the formula is the volume (cm³) of the component where the area was sealed.

Evaluation

(1) Evaluation Part 1: Comparison of Rod Types and Sintered Types

The sealing materials of Examples 1 and 2 and Comparative Examples 1 through 3 were measured for leakage when tightened under the conditions given in Table 1 (tightening pressure, surface roughness of tightening area). The beginnings and ends of the sealing tape were cut into tapered form and joined, with the ends overlapped in such a way that the longitudinal end partially rode up on the beginning (the thickness of the overlapping part was no more than 1.1 times the thickness of the sealing tape), giving sealing materials in the form of closed rings with an inside diameter of 60 mm and an outside diameter of 80 mm.

The results are given in Table 1.

TABLE 1

| | | Conditions of measurement | | | |
|---|---|---|---|---|---|
| | | Smooth | | Rough | |
| | | surface (0.5 a) | | surface (10 a) | |
| | Features | 1 MPa | 2.5 MPa | 1 MPa | 2.5 MPa |
| Example | film laminate type, with | less than | less than | 0.0023 | less |
| 1 | fluid prevention layer | 0.0001 | 0.0001 | | than |
| | | | | | 0.0001 |
| Example | film laminate type, with | less than | ND | ND | ND |
| 2 | fluid prevention layer | 0.0001 | | | |
| Comp. | rod type | 0.094 | 0.0083 | 0.085 | 0.010 |
| Ex.1 | | | | | |
| Comp. | rod type | 0.22 | ND | ND | ND |
| Ex.2 | | | | | |
| Comp. | sintered type | 0.0042 | less than | gross | gross |
| Ex.3 | | | 0.0001 | leak | leak |

ND = Not Determined

On smooth surfaces, the sintered ePTFE sealing material (Comparative Example 3) had better sealing properties than the rod-shaped sealing material (Comparative Example 1), but the adhesion was poorer on rough tightening surfaces, detraction from its function as a sealing material. On both smooth and rough surfaces, the sealing properties were not as good as those of the sealing tape of the present invention (Example 1).

At a tightening pressure of 2.5 MPa, the rod type (Comparative Example 1) had relatively high sealing properties on smooth and rough surfaces, but the sealing properties were lower at a tightening pressure of 1 MPa.

The sealing material in Example 1 of the present invention had high sealing performance on both smooth and rough surfaces at both tightening pressures 1 MPa and 2.5 MPa.

The same was true of the smaller sealing materials (Example 2, Comparative Example 2).

(2) Evaluation Part 2: Comparison of Film Laminating Direction

The beginnings and ends of the sealing tape in Example 3 and Comparative Example 4 were cut into tapered form and joined, with the ends overlapped in such a way that the longitudinal end partially rode up on the beginning (the thickness of the overlapping part was no more than 1.1 times the thickness of the sealing tape), giving sealing materials in the form of closed rings with an inside diameter of 210 mm and an outside diameter of 250 mm. The film in Example 3 was laminated in a direction aligned with the radial direction of the closed-ring seal, while the film in Comparative Example 4 was laminated in a direction aligned with the thicknesswise direction of the closed-ring seal. The closed-ring seals were measured for leakage in the same manner as above at a container internal pressure of 0.2 MPa and a tightening pressure of 5 MPa on an 0.5 a smooth surface. The results are given in Table 2.

TABLE 2

| | | Measuring conditions |
|---|---|---|
| | Features | Smooth surface: 0.5 a; |
| | (direction in which film | tightening pressure: |
| | was laminated) | 5 MPa |
| Example 3 | fluid penetration- | 0.00014 |
| | preventing layer in | |
| | radial direction of ring | |
| Comparative | thicknesswise | 0.00040 |
| Example 4 | direction of ring | |

Table 2 shows that the sealing material of the present invention (Example 3) was better. In short, the sealing material of the present invention was laminated in the radial direction in which the ePTFE film inhibits the direction of leakage. Even though the two films were made of the same material, the fluid penetration-preventing layer prevented penetration leakage to a higher degree, giving sealing properties that were better than those of the sealing material in Comparative Example 4, where the ePTFE film was laminated in the direction of the pipe axis,.

(3) Evaluation Part III: Comparison of Sealing Material in the Form of Tape and in the Form of Rings

The sealing materials of Example 3 and Comparative Example 5 were measured for leakage in the same manner as above at a container internal pressure of 0.1 MPa and a tightening pressure of 1 MPa on a 10 a rough surface. The longitudinal beginning and end of the sealing tape in Example 3 were cut into tapered form, with the ends overlapped in such a way that the longitudinal end partially rode up on the beginning (the thickness of the overlapping part was no more than 1.1 times the thickness of the sealing tape), giving a closed ring with an inside diameter of 60 mm and an outside diameter of 70 mm. The results are given in Table 3.

TABLE 3

| | | | | Measuring |
|---|---|---|---|---|
| | Features | | | conditions |
| | | | Density | Roughness: 10 a |
| | | | y | Tightening |
| | Laminated direction | Type | (g/cm³) | pressure: 1 MPa |
| Example 2 | radial direction of | tape | 0.68 | 0.0044 |
| | ring | type | | |
| Comp. | thicknesswise | ring | 0.87 | 0.050 |
| Ex. 5 | direction of ring | type | | |

Although both Example 2 and Comparative Example 5 had layers to prevent fluid from penetrating and had the ePTFE film laminated in the same direction, the sealing material in the example of the present invention had better sealing properties. The sealing material of Comparative Example 5 had greater density than that in Example 2, which presumably explained the greater wrapping constriction of the sealing material in Comparative Example 5 during the wrapping lamination process and its resulting hardness. This seems to have led to less conformability on the tightening surface and lower sealing properties on rough surfaces.

Advantage of the Invention

The sealing material in the form of tape in the present invention is made of a laminate of ePTFE film strips, making it more flexible, with better adhesion on tightening surfaces on rough surfaces at lower tightening pressure, and thus better prevention of interfacial leakage. When made in the form of a closed ring, the film is laminated in the radial direction, allowing leakage through the sealing material itself to be prevented. A layer for preventing fluid penetrating leakage can also be interposed between the layers of the laminated ePTFE film strips, further enhancing the sealing properties.

The sealing material in the form of tape in the present invention is a flexible tape, allowing it to conform to the shape of housings and the like that have more complex shapes, and the longitudinal beginning and end can be joined to form a seal in the form of a closed ring, making it suitable as a seal for a wider variety of devices and parts.

The manufacturing method of the present invention enables the efficient production of the sealing tape in the present invention.

1. A sealing material comprising a tape comprising a laminate having a height and a width and comprising a plurality of expanded porous polytetrafluoroethylene film, wherein the height of the laminate is greater than the width of the laminate.

2. A sealing material according to claim 1, wherein said laminate has end faces along said height and the end faces areadapted to contact tightened surfaces of a vessel to be sealed.

3. A sealing material according to claim 2, wherein an adhesive component is applied to at least one end face of said laminate.

4. A sealing material according to claim 3, wherein release paper is applied to the adhesive component.

5. A sealing material comprising a plurality of laminates according to claim 1,

6. A sealing material according to claim 5, wherein said laminates have end faces along said height and an adhesive component is provided on at least one end face.

7. A sealing material according to claim 5, wherein the laminates are joined by being thermally fused using a tetrafluoroethylene-hexafluoropropylene copolymer film or tetrafluoroethylene-perfluoroalkyl vinyl ether copolymer film.

8. A sealing material according to claim 1, wherein at least one layer for preventing fluid penetration is interposed in the laminate.

9. A sealing material according to claim 8, wherein the layer for preventing fluid penetration comprises a fluororesin film.

10. A sealing material according to claim 9, wherein the fluororesin film comprises a compact polytetrafluoroethylene film.

11. A sealing material according to claim 10, wherein the compact polytetrafluoroethylene film comprises an expanded porous polytetrafluoroethylene in which the pores have been crushed flat under pressure.

12. A sealing material according to claim 1, wherein the laminate is adhesively unified through sintering of the expanded porous polytetrafluoroethylene films.

13. A sealing material according to claim 1 which has been joined at the longitudinal beginning and end to form a closed ring, wherein the direction in which the laminated strips have been laminated is the radial direction of the closed ring.

14. A sealing material according to claim 13, wherein the beginning and end are joined by adhesion with double sided adhesive tape.

15. A method for producing a sealing material in the form of tape, comprising the steps of:
laminating a predetermined number of sheets of expanded porous polytetrafluoroethylene film to produce a first laminate;
slitting the first laminate to a predetermined width to obtain laminates in the form of strips having a height and a width, said height being greater than said width, with end faces along said height; and
affixing or applying an adhesive to the end faces.

16. A method for producing a sealing material in the form of tape according to claim 15, comprising cutting and spreading out an expanded porous polytetrafluoroethylene film laminate in the form of a cylinder which has been obtained by being wrapped around a mandrel.

17. A method for producing a sealing material according to claim 16, wherein a fluororesin film is interposed in the first laminate.

18. A method for producing a sealing material according to claim 17, wherein the fluororesin film comprises a compact polytetrafluoroethylene film, said compact polytetrafluoroethylene film comprising a spirally laminated expanded porous polytetrafluoroethylene film in which the pores have been crushed flat under pressure.

19. A method for producing a sealing material according to claim 15, comprising a step for sintering the first laminate after the step for producing the first laminate and before the step for slitting it to a predetermined width.

20. A sealing material according to claim 8 wherein said layer for preventing fluid penetration comprises an elastomer. 21. A sealing material according to claim 20 wherein said layer for preventing fluid penetration comprises Sifel®.
